(19) United States
(12) Patent Application Publication
(10) Pub. No.: US 2025/0322263 A1
(43) Pub. Date: Oct. 16, 2025

(54) EMPOWERING DIGITAL HUMAN COMPANIONS WITH EMPATHY AND TRUST BASED CONNECTION POINTS

(71) Applicant: International Business Machines Corporation, Armonk, NY (US)

(72) Inventors: Jennifer M. Hatfield, Portland, OR (US); Jana H. Jenkins, Raleigh, NC (US); Paige Min, Tenafly, NJ (US); Erin McPhail, Liberty Hill, TX (US); Neil Delima, Scarborough (CA); Jeremy R. Fox, Georgetown, TX (US)

(21) Appl. No.: 18/633,130

(22) Filed: Apr. 11, 2024

(51) Int. Cl. G06N 5/022

(52) U.S. Cl. CPC G06N 5/022

(57) ABSTRACT

In an approach for employing digital human technology, incorporating advanced artificial intelligence and natural language processing, to facilitate a more personalized and a more human-like interaction with a user, a processor initiates an interaction between a digital human companion and a user in response to an input from the user. A processor derives a connection point from the interaction between the digital human companion and the user to build a relationship with the user. A processor prepares a first response to the input from the user incorporating the connection point. A processor outputs the first response to the user. A processor incorporates a set of feedback received from the user to customize the digital human companion to increase a first level of intelligence and a second level of adaptability of the digital human companion.

### BACKGROUND OF THE INVENTION

The present invention relates generally to a digital human companion, and more particularly to a computer-implemented method, a computer system, and a computer program product configured and arranged to empower a digital human companion with empathy and trust-based connection points.

Artificial intelligence, or AI, is a technology that enables a computer or a computer-controlled robot to perform a task that would otherwise require human intelligence and intervention. The term AI is frequently applied to a computer or a computer-controlled robot endowed with the intellectual processes characteristic of humans, such as the ability to reason, discover meaning, generalize, and learn from past experiences. Despite continuing advances in computer processing speed and memory capacity, there are no programs that can match full human flexibility over wider domains or tasks requiring much everyday knowledge. Some programs, however, have attained the performance levels of human experts and professionals in performing certain specific tasks. AI in this limited sense is found in applications as diverse as medical diagnosis, computer search engines, voice or handwriting recognition, and chatbots.

Machine learning is a first branch of AI. Machine learning focuses on the use of data and involves the development of AI algorithms, modeled after the decision-making processes of the human brain, that can ‘learn’ from available data and make increasingly more accurate classifications or predictions over time. In general, a machine learning algorithm is used to make a prediction or classification. Based on some input data, which can be labeled or unlabeled, the machine learning algorithm will produce an estimate about a pattern in the data. An error function evaluates the prediction of the model. If there are known examples, an error function can make a comparison to assess the accuracy of the model. If the model can better fit the data points in the training set, then weights are adjusted to reduce the discrepancy between the known example and the model estimate. The machine learning algorithm will repeat this “evaluate and optimize” process, updating weights autonomously until a threshold of accuracy has been met.

Natural language processing (NLP) is a second branch of AI. NLP focuses on giving computers the ability to understand written text and spoken words in a similar way to how human beings can. NLP combines computational linguistics—rule-based modeling of human language—with statistical, machine learning, and deep learning models. Together, these technologies enable computers to process human language in the form of text or voice data and to ‘understand’ its full meaning, complete with the speaker or writer's intent and sentiment.

### SUMMARY

Aspects of an embodiment of the present invention disclose a method, computer program product, and computer system for employing digital human technology, incorporating advanced artificial intelligence and natural language processing, to facilitate a more personalized and a more human-like interaction with a user. A processor initiates an interaction between a digital human companion and a user in response to an input from the user. A processor derives a connection point from the interaction between the digital human companion and the user to build a relationship with the user. A processor prepares a first response to the input from the user incorporating the connection point. A processor outputs the first response to the user. A processor incorporates a set of feedback received from the user to customize the digital human companion to increase a first level of intelligence and a second level of adaptability of the digital human companion.

In some aspects of an embodiment of the present invention, the connection point is at least one of a mental state of the user, an emotional state of the user, a tone of voice of the user, a verbal cue of the user, and a non-verbal cue of the user.

In some aspects of an embodiment of the present invention, the relationship is built on one or more characteristics, and wherein the one or more characteristics include at least one of trust of the user and empathy with the user.

In some aspects of an embodiment of the present invention, the first response to the input from the user incorporates the connection point by including at least one of a reference to a previous interaction with the user, a first mirroring of the mental state of the user, a second mirroring of the emotional state of the user, a third mirroring of the tone of voice of the user, a second response to the verbal cue of the user, a third response to the non-verbal cue of the user, a first summarization of a first understanding of a feeling expressed by the user, a summarization of a second understanding of a need expressed by the user, and a manifestation of a thoughtful question based on the previous interaction with the user.

In some aspects of an embodiment of the present invention, a processor communicates a first reason an action was taken to help the user understand why the action was taken. A processor communicates a second reason a recommendation was made in order to help the user understand why the recommendation was made.

In some aspects of an embodiment of the present invention, a first communication of the first reason the action was taken and a second communication of the second reason the recommendation was made is implemented through a dialogue management system and a machine learning algorithm, wherein the dialogue management system and the machine learning algorithm understands a context, a continuity, and a subtlety of a human-to-human interaction.

In some aspects of an embodiment of the present invention, a processor recognizes one or more relationships of the user. A processor learns about a degree of importance of the one or more relationships of the user. A processor considers the one or more relationships in at least one of a corresponding input and a corresponding output.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a functional block diagram illustrating a distributed data processing environment, in accordance with an embodiment of the present invention;

FIG. 2 is a flowchart illustrating the operational steps of a digital human companion program, on a server within the distributed data processing environment of FIG. 1, in accordance with an embodiment of the present invention; and

FIG. 3 depicts a block diagram of components of a computing environment representing the distributed data processing environment of FIG. 1, in accordance with an embodiment of the present invention.

### DETAILED DESCRIPTION

Embodiments of the present invention recognize that a digital human is a human-like, artificially intelligent (AI) persona with the behavior, personality, and knowledge of a human. A digital human can be more engaging than a chatbot, and can interpret speech, gestures, and images, as well as generate its own speech, tone, and body language. A digital human can be used in a plurality of capacities. For example, a digital human can be used as a customer support representative, a career coach, and/or an aged-care companion.

Embodiments of the present invention recognize that a current state of the art of a virtual assistant, a digital assistant, and a personal robot does not have the ability to enhance the healthcare and the wellbeing of a growing ageing population, does not have the ability to use technology to provide companionship to combat loneliness and isolation experienced by the growing ageing population, and does not have the ability to establish a relationship of trust between an elderly patient of the growing ageing population and technology.

Embodiments of the present invention, however, recognize that there exists an opportunity to produce a more human digital companion experience with empathetic and trustworthy characteristics to better meet a user's individual needs. Embodiments of the present invention recognize that there exists an opportunity to develop a digital human companion to look and sound like a human being and to have the ability to have rich interactive capabilities with a user and deep personality traits such as the traits of trust and empathy. Therefore, embodiments of the present invention recognize the need for a more human digital companion experience that is a virtual assistant with the ability to establish a trusted relationship with a user and with the ability to provide the user with personalized communication and guidance.

Embodiments of the present invention provide a system and method to employ digital human technology, incorporating advanced artificial intelligence and natural language processing, to facilitate a more personalized and a more human-like interaction with a user. Embodiments of the present invention provide a system and method to offer personalized communication, guidance, and support to a user by integrating one or more features such as by mirroring and reacting to human behavior; by asking the user a question; by demonstrating an understanding of a behavior, an emotion, and/or a preference of the user. Embodiments of the present invention provide a system and method to facilitate the interaction with the user similar to how the user would feel when the user is talking to a trusted friend, advisor, and/or loved one in order to build a relationship of empathy and trust with the user.

Implementation of embodiments of the present invention may take a variety of forms, and exemplary implementation details are discussed subsequently with reference to the Figures.

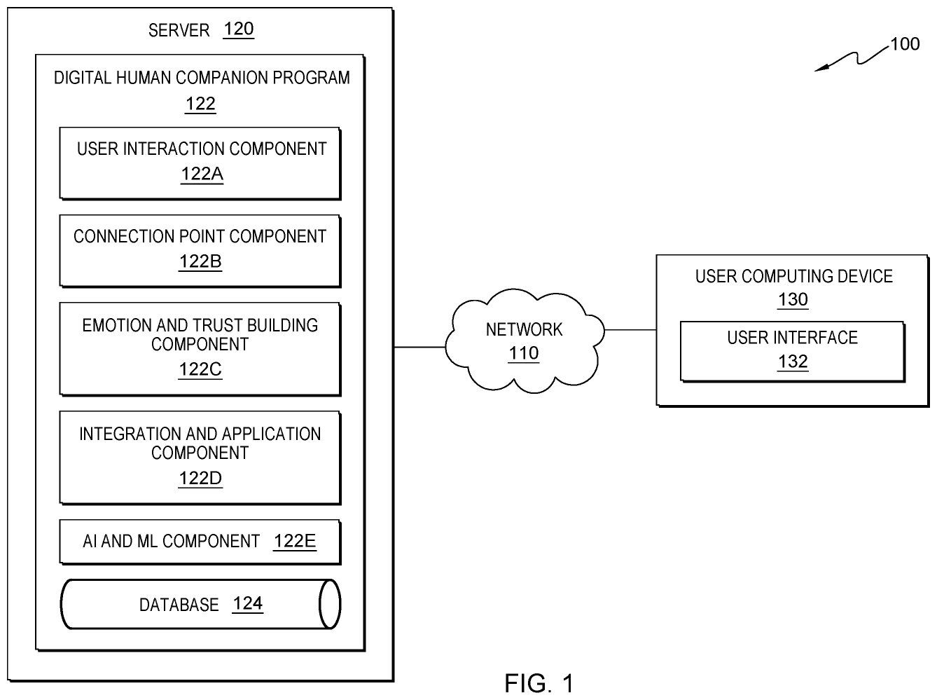

FIG. 1 is a block diagram illustrating a distributed data processing environment, generally designated 100, in accordance with an embodiment of the present invention. In the depicted embodiment, distributed data processing environment 100 includes server 120 and user computing device 130, interconnected over network 110. Distributed data processing environment 100 may include additional servers, computers, computing devices, and other devices not shown. The term “distributed” as used herein describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120, user computing device 130, and other computing devices (not shown) within distributed data processing environment 100.

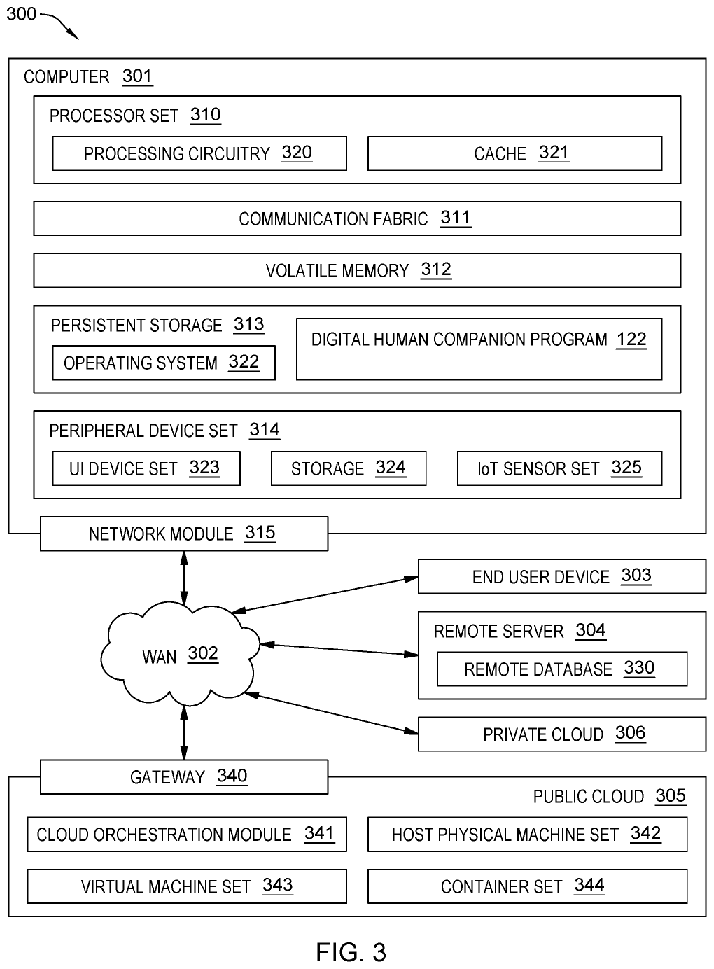

Server 120 operates to run digital human companion program 122 and to send and/or store data in database 124. In an embodiment, server 120 can send data from database 124 to user computing device 130. In an embodiment, server 120 can receive data in database 124 from user computing device 130. In an embodiment, server 120 includes digital human companion program 122 and database 124. In one or more embodiments, server 120 can be a standalone computing device, a management server, a web server, a mobile computing device, or any other electronic device or computing system capable of receiving, sending, and processing data and capable of communicating with user computing device 130 via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130 and other computing devices (not shown) within distributed data processing environment 100 via network 110. Server 120 may include internal and external hardware components, as depicted and described in further detail in FIG. 3.

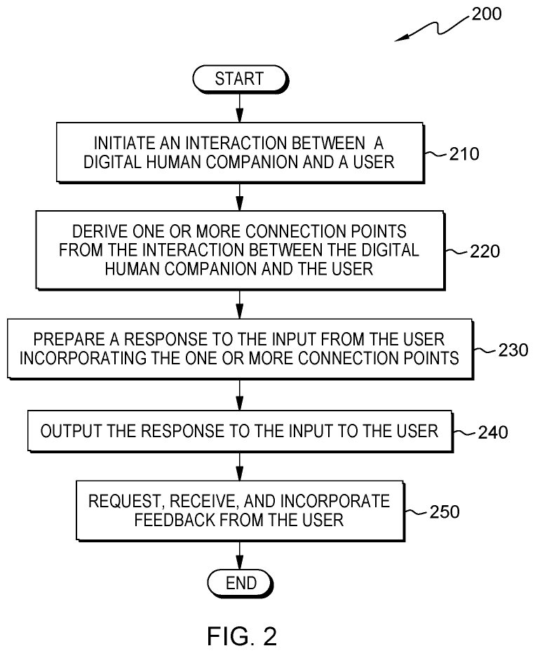

Digital human companion program 122 operates to employ digital human technology, incorporating advanced artificial intelligence and natural language processing, to facilitate a more personalized and a more human-like interaction with a user. Digital human companion program 122 operates to offer personalized communication, guidance, and support to a user by integrating one or more features into the interaction with the user, such as mirroring and reacting to human behavior; asking the user a question; and demonstrating an understanding of a behavior, an emotion, and/or a preference of the user. Digital human companion program 122 operates to facilitate the interaction with the user similar to how the user would feel when the user is talking to a trusted friend, advisor, and/or loved one in order to build a relationship of empathy and trust with the user. In the depicted embodiment, digital human companion program 122 is a standalone program. In another embodiment, digital human companion program 122 may be integrated into another software product. In the depicted embodiment, digital human companion program 122 includes user interaction component 122-A, connection point component 122-B, emotion and trust building component 122-C, integration and application component 122-D, and artificial intelligence and machine learning component 122-E. The operational steps of digital human companion program 122 are depicted and described in further detail with respect to FIG. 2.

User interaction component 122-A of digital human companion program 122 operates to initiate an interaction between a digital human companion and a user. Connection point component 122-B of digital human companion program 122 operates to derive one or more connection points from one or more key moments during the interaction between the digital human companion and the user to build a relationship with the user. Emotion and trust building component 122-C of digital human companion program 122 operates to prepare a response to the input incorporating one or more connection points. By responding in a way that incorporates the one or more connection points, emotion and trust building component 122-C of digital human companion program 122 responds in an empathic way to the user. Additionally, emotion and trust building component 122-C of digital human companion program 122 operates to prepare a response to the input that communicates one or more actions and one or more intentions transparently (i.e., in a way that builds trust with the user). Integration and application component 122-D of digital human companion program 122 operates to output the response to the user through the point of contact. Artificial intelligence and machine learning component 122-E of digital human companion program 122 operates to request, receive, process, and incorporate feedback on the interaction with the digital human companion from the user and the system. Artificial intelligence and machine learning component 122-E of digital human companion program 122 operates to incorporate feedback on the interaction to increase a level of intelligence of the digital human companion and to increase a level of adaptability of the digital human companion.

In an embodiment, a user of a user computing device (e.g., user computing device 130) registers with digital human companion program 122 of server 120. For example, the user completes a registration process (e.g., user validation), provides information to create a user profile, and authorizes the collection, analysis, and distribution (i.e., opts-in) of relevant data on an identified computing device (e.g., user computing device 130) by server 120 (e.g., via digital human companion program 122). Relevant data includes, but is not limited to, personal information or data provided by the user; tagged and/or recorded location information of the user (e.g., to infer context (i.e., time, place, and usage) of a location or existence); time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 124.

Database 124 operates as a repository for data received, used, and/or generated by digital human companion program 122. A database is an organized collection of data. Data includes, but is not limited to, information about user preferences (e.g., general user system settings such as alert notifications for a user computing device (e.g., user computing device 130)); information about alert notification preferences; and any other data received, used, and/or generated by digital human companion program 122.

Database 124 can be implemented with any type of device capable of storing data and configuration files that can be accessed and utilized by server 120, such as a hard disk drive, a database server, or a flash memory. In an embodiment, database 124 is accessed by digital human companion program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that digital human companion program 122 has access to database 124.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Digital human companion program 122 enables the authorized and secure processing of personal data and/or confidential company data.

Digital human companion program 122 provides informed consent, with notice of the collection of personal and/or confidential company data, allowing the user to opt-in or opt-out of processing personal and/or confidential company data. Consent can take several forms. Opt-in consent can impose on the user to take an affirmative action before personal and/or confidential company data is processed. Alternatively, opt-out consent can impose on the user to take an affirmative action to prevent the processing of personal and/or confidential company data before personal and/or confidential company data is processed. Digital human companion program 122 provides information regarding personal and/or confidential company data and the nature (e.g., type, scope, purpose, duration, etc.) of the processing. Digital human companion program 122 provides the user with copies of stored personal and/or confidential company data. Digital human companion program 122 allows the correction or completion of incorrect or incomplete personal and/or confidential company data. Digital human companion program 122 allows for the immediate deletion of personal and/or confidential company data.

User computing device 130 operate to run user interface 132 through which users can interact with digital human companion program 122 on server 120. In an embodiment, user computing device 130 is a device that performs programmable instructions. For example, user computing device 130 may be an electronic device, such as a laptop computer, a tablet computer, a netbook computer, a personal computer, a desktop computer, a smart phone, a health tracking device, an entertainment system, a robotic machine, or any programmable electronic device capable of running user interface 132 and of communicating (i.e., sending and receiving data) with digital human companion program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 includes an instance of user interface 132.

User interface 132 operates as a local user interface between digital human companion program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from digital human companion program 122 to a user via network 110. User interface 132 can also display or present alerts including information (such as graphics, text, and/or sound) sent from digital human companion program 122 to a user via network 110. In an embodiment, user interface 132 can send and receive data (i.e., to and from digital human companion program 122 via network 110, respectively). Through user interface 132, a user can opt-in to digital human companion program 122; input information; create a user profile; set user preferences and alert notification preferences; submit an input; receive a response; receive a request for feedback; and input feedback.

A user preference is a setting that can be customized for a particular user. A set of default user preferences are assigned to each user of digital human companion program 122. A user preference editor can be used to update values to change the default user preferences. User preferences that can be customized include, but are not limited to, general user system settings, specific user profile settings, alert notification settings, and machine-learned data collection/storage settings. Machine-learned data is a user's personalized corpus of data. Machine-learned data includes, but is not limited to, past results of iterations of digital human companion program 122.

FIG. 2 is a flowchart, generally designated 200, illustrating the operational steps for digital human companion program 122, on server 120 within distributed data processing environment 100 of FIG. 1, in accordance with an embodiment of the present invention. In an embodiment, digital human companion program 122 operates to employ digital human technology, incorporating advanced artificial intelligence and natural language processing, to facilitate a more personalized and a more human-like interaction with a user. In an embodiment, digital human companion program 122 operates to offer personalized communication, guidance, and support to a user by integrating one or more features into the interaction with the user, such as mirroring and reacting to human behavior; asking the user a question; and demonstrating an understanding of a behavior, an emotion, and/or a preference of the user. In an embodiment, digital human companion program 122 facilitates the interaction with the user similar to how the user would feel when the user is talking to a trusted friend, advisor, and/or loved one in order to build a relationship of empathy and trust with the user. It should be appreciated that the process depicted in FIG. 2 illustrates one possible iteration of the process flow, which may be repeated each time an interaction is initiated between a digital human companion and a user.

In step 210, user interaction component 122-A of digital human companion program 122 (hereinafter referred to as “user interaction component 122-A”) initiates an interaction between a digital human companion and a user. In an embodiment, user interaction component 122-A initiates an interaction between a digital human companion and a user proactively (i.e., without the user initiating the interaction). In another embodiment, user interaction component 122-A enables a user to initiate an interaction between a digital human companion and a user. A user is, but is not limited to, a human individual who benefits from a display of companionship and support. For example, a user is a human individual who is elderly and/or a human individual who is experiencing isolation. In an embodiment, user interaction component 122-A enables the user to initiate an interaction between the digital human companion and the user through a point of contact. A point of contact is a user interface (e.g., user interface 132) of a user computing device (e.g., user computing device 130). A point of contact encompasses an ability of a digital human companion to mimic a human behavior. A human behavior is a potential and expressed capacity (i.e., mentally, physically, and socially) of a human individual to respond to internal and external stimuli throughout the life of the human individual. A human behavior is a form of non-verbal communication. A human behavior includes, but is not limited to, a facial expression, a body movement and posture, a gesture, eye contact, touch, space (i.e., physical space), and voice (i.e., it is not what you say, but rather how you say it). Additionally, a point of contact encompasses an ability of a digital human companion to understand and respond to a form of verbal communication of a user. In another embodiment, user interaction component 122-A enables a user to initiate an interaction with a digital human companion through a use of a user experience technology. A user experience technology includes, but is not limited to, a three-dimensional (3D) modelling technology, a realistic avatar, and a natural language generation technology. In an embodiment, user interaction component 122-A enables a user to initiate an interaction with a digital human companion by submitting an input. In an embodiment, user interaction component 122-A analyzes the input. In an embodiment, user interaction component 122-A analyzes the input using a Natural Language Processing (NLP) technology. In another embodiment, user interaction component 122-A analyzes the input using a speech recognition technology. In another embodiment, user interaction component 122-A analyzes the input using a computer vision algorithm.

In step 220, connection point component 122-B of digital human companion program 122 (hereinafter referred to as “connection point component 122-B”) derives one or more connection points. In an embodiment, connection point component 122-B derives one or more connection points from one or more key moments during the interaction between the digital human companion and the user. In an embodiment, connection point component 122-B derives one or more connection points to build a relationship with the user. The relationship is built on one or more characteristics. The one or more characteristics include, but are not limited to, at least one of empathy with the user and trust of the user. In an embodiment, connection point component 122-B derives one or more connection points from the input (i.e., received by user interaction component 122-A in step 210). In another embodiment, connection point component 122-B derives one or more connection points from a previous interaction between the digital human companion and the user.

In step 230, emotion and trust building component 122-C of digital human companion program 122 (hereinafter referred to as “emotion and trust building component 122-C”) prepares a response. In an embodiment, emotion and trust building component 122-C prepares a response to the input (i.e., received from the user by user interaction component 122-A in step 210). In an embodiment, emotion and trust building component 122-C prepares a response to the input incorporating one or more connection points (i.e., derived from the input by connection point component 122-B in step 220). The one or more connection points include, but are not limited to, a mental state of the user, an emotional state of the user, a tone of voice of the user, a verbal cue of the user, and a non-verbal cue of the user. In an embodiment, emotion and trust building component 122-C prepares a response to the input incorporating one or more connection points to respond empathically to the user (i.e., in a way that shows an ability to understand and to share the feelings of the user). In an embodiment, emotion and trust building component 122-C prepares a response to the input that communicates one or more actions and one or more intentions transparently.

In an embodiment, concurrently with emotion and trust building component 122-C preparing the response to the input incorporating one or more connection points, connection point component 122-B deepens one or more connection points between the digital human companion and the user. In an embodiment, connection point component 122-B deepens one or more connection points by leveraging one or more techniques. The one or more techniques include, but are not limited to, a reference to a previous interaction with the user, a mirroring of a mental state of the user, a mirroring of an emotional state of the user, a mirroring of a tone of voice of the user, a response to a verbal cue of the user, a response to a non-verbal cue of the user (e.g., a sentiment analysis technique and/or an emotion recognition algorithm), active listening and a summarization of an understanding of a feeling expressed by the user, active listening and a summarization of an understanding of a need expressed by the user, and a manifestation of a thoughtful question based on the previous interaction with the user. In an embodiment, connection point component 122-B references artificial intelligence and machine learning component 122-E to decide how to respond to the input appropriately.

In an embodiment, concurrently with emotion and trust building component 122-C preparing the response to the input incorporating one or more connection points, connection point component 122-B recognizes one or more relationships in a life of the user (e.g., a family member, a friend, a support human, a doctor, and a dog walker). In an embodiment, connection point component 122-B learns about the one or more relationships in the life of the user (e.g., a degree of importance of a relationship in the life of the user). In an embodiment, connection point component 122-B considers the one or more relationships in a resulting and corresponding input and/or output. In an embodiment, connection point component 122-B references integration and application component 122-D to incorporate the one or more relationships in a resulting and corresponding input and/or output (i.e., in a real-world context).

In a first example of a connection point (i.e., a shared experience), digital human companion program 122 references a previous conversation, interaction, experience, and/or preference. Digital human companion program 122 references the previous conversation, interaction, experience, and/or preference to show the user that digital human companion program 122 understands and remembers the shared history. In a second example of a connection point (i.e., an empathetic response), digital human companion program 122 responds to the user with an appropriate emotional cue when the user shares information that is exciting or sad. Digital human companion program 122 demonstrates an understanding of the information the user shared as well as empathy for the way the user is feeling. In a third example of a connection point (i.e., a unique and personalized recommendation), digital human companion program 122 provides a personalized recommendation based on a preference and/or a past behavior of the user. Digital human companion program 122 may recommend a new movie, a new walking route, or a new recipe to try. Digital human companion program 122 may even alert the user to a missed normal habitual activity or step, such as brushing one's teeth. In a fourth example of a connection point (i.e., a check-in from a previous conversation), digital human companion program 122 proactively initiates a conversation based on a habit and/or an emotional state of the user. Digital human companion program 122 may ask how the user is feeling after a long day or may ask the user if the user would like to talk about a recent event. In a fifth example of a connection point (i.e., a transparent action), digital human companion program 122 explains to the user why digital human companion program 122 is making a certain recommendation and/or taking a certain action. In a sixth example of a connection point (i.e., adapting to a tone of voice and/or a body language of the user), digital human companion program 122 recognizes a change in a tone of voice and/or a body language of the user. Digital human companion program 122 responds accordingly by speaking in a softer tone of voice if the user seems upset or by showing excitement when the user is happy. In a seventh example of a connection point (i.e., celebrating a milestone of the user), digital human companion program 122 remembers and celebrates an important date (e.g., a birthday and/or an anniversary) and an important milestone (e.g., a completion of a long-term goal). In an eighth example of a connection point (i.e., responsive listening to the user), digital human companion program 122 provides an active listening cue, such as nodding or saying “uh-huh”, and asks follow-up questions that demonstrate an interest and a comprehension of what the user said. Digital human companion program 122 also summarizes what it understands from an input of the user to show attentiveness.

In step 240, integration and application component 122-D of digital human companion program 122 (hereinafter referred to as “integration and application component 122-D”) outputs the response to the user. In an embodiment, integration and application component 122-D outputs the response to the user through the point of contact. In an embodiment, if requested by the user, integration and application component 122-D defines a use case scenario specific to the response. In an embodiment, if defining the use case scenario, integration and application component 122-D fine-tunes the response to the use case scenario.

In an embodiment, connection point component 122-B communicates the response to the user transparently. In an embodiment, connection point component 122-B communicates the response to the user transparently to build the trust of the user. In an embodiment, connection point component 122-B communicates a reason an action was taken to help the user understand why the action was taken. In an embodiment, connection point component 122-B communicates a reason a recommendation was made to help the user understand why the recommendation was made. In an embodiment, connection point component 122-B communicates the reason through a dialogue management system and a machine learning algorithm. The dialogue management system and the machine learning algorithm understands a context, a continuity, and a subtlety of a human-to-human interaction.

In step 250, artificial intelligence and machine learning component 122-E of digital human companion program 122 (hereinafter referred to as “artificial intelligence and machine learning component 122-E”) requests feedback on the interaction with the digital human companion from the user. In another embodiment, artificial intelligence and machine learning component 122-E requests feedback on the interaction with the digital human companion and the user from the system. In an embodiment, artificial intelligence and machine learning component 122-E requests feedback on the interaction with the digital human companion from the user through the point of contact. In another embodiment, artificial intelligence and machine learning component 122-E requests feedback on behavior adaption. In an embodiment, artificial intelligence and machine learning component 122-E requests feedback on a complex decision-making process.

In an embodiment, artificial intelligence and machine learning component 122-E processes the feedback received on the interaction with the digital human companion from the user utilizing a machine learning algorithm. In another embodiment, artificial intelligence and machine learning component 122-E processes the feedback received on behavior adaption utilizing reinforcement learning. In another embodiment, artificial intelligence and machine learning component 122-E processes the feedback received on the complex decision-making processes utilizing a deep learning model.

In an embodiment, artificial intelligence and machine learning component 122-E incorporates the feedback received on the interaction with the digital human companion from the user. In an embodiment, artificial intelligence and machine learning component 122-E incorporates the feedback received to increase a level of intelligence of the digital human companion (e.g., to learn from a previous interaction between the digital human companion and the user and to provide a personalized suggestion to the user). In an embodiment, artificial intelligence and machine learning component 122-E incorporates the feedback to increase a level of adaptability of the digital human companion (e.g., to a behavior and/or a preference of the user).

FIG. 3 depicts a block diagram of components of server 120 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Computing environment 300 contains an example of an environment for the execution of at least some of the computer code involved in performing the inventive methods, such as digital human companion program 122. In addition to digital human companion program 122, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and digital human companion program 122, as identified above), peripheral device set 314 (including user interface (UI), device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301, which represents server 120 of FIG. 1, may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in digital human companion program 122 in persistent storage 313.

Communication fabric 311 is the signal conduction paths that allow the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, the volatile memory is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid-state storage devices. Operating system 322 may take several forms, such as various known proprietary operating systems or open-source Portable Operating System Interface type operating systems that employ a kernel. The code included in digital human companion program 122 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
initiating, by one or more processors, an interaction between a digital human companion and a user in response to an input from the user;
deriving, by the one or more processors, a connection point from the interaction between the digital human companion and the user to build a relationship with the user;
preparing, by the one or more processors, a first response to the input from the user incorporating the connection point;
outputting, by the one or more processors, the first response to the user; and
incorporating, by the one or more processors, a set of feedback received from the user to customize the digital human companion to increase a first level of intelligence and a second level of adaptability of the digital human companion.

2. The computer-implemented method of claim 1, wherein the connection point is at least one of a mental state of the user, an emotional state of the user, a tone of voice of the user, a verbal cue of the user, and a non-verbal cue of the user.

3. The computer-implemented method of claim 1, wherein the relationship is built on one or more characteristics, and wherein the one or more characteristics include at least one of trust of the user and empathy with the user.

4. The computer-implemented method of claim 1, wherein the first response to the input from the user incorporates the connection point by including at least one of a reference to a previous interaction with the user, a first mirroring of the mental state of the user, a second mirroring of the emotional state of the user, a third mirroring of the tone of voice of the user, a second response to the verbal cue of the user, a third response to the non-verbal cue of the user, a first summarization of a first understanding of a feeling expressed by the user, a summarization of a second understanding of a need expressed by the user, and a manifestation of a thoughtful question based on the previous interaction with the user.

5. The computer-implemented method of claim 1, wherein the step of outputting the first response to the user further comprises:
communicating, by the one or more processors, a first reason an action was taken to help the user understand why the action was taken; and
communicating, by the one or more processors, a second reason a recommendation was made in order to help the user understand why the recommendation was made.

6. The computer-implemented method of claim 5, wherein a first communication of the first reason the action was taken and a second communication of the second reason the recommendation was made is implemented through a dialogue management system and a machine learning algorithm, wherein the dialogue management system and the machine learning algorithm understands a context, a continuity, and a subtlety of a human-to-human interaction.

7. The computer-implemented method of claim 1, further comprising:
recognizing, by the one or more processors, one or more relationships of the user;
learning, by the one or more processors, about a degree of importance of the one or more relationships of the user; and
considering, by the one or more processors, the one or more relationships in at least one of a corresponding input and a corresponding output.

8. A computer program product comprising:
one or more computer readable storage media and program instructions stored on the one or more computer readable storage media, the program instructions comprising:
program instructions to initiate an interaction between a digital human companion and a user in response to an input from the user;
program instructions to derive a connection point from the interaction between the digital human companion and the user to build a relationship with the user;
program instructions to prepare a first response to the input from the user incorporating the connection point;
program instructions to output the first response to the user; and
program instructions to incorporate a set of feedback received from the user to customize the digital human companion to increase a first level of intelligence and a second level of adaptability of the digital human companion.

9. The computer program product of claim 8, wherein the connection point is at least one of a mental state of the user, an emotional state of the user, a tone of voice of the user, a verbal cue of the user, and a non-verbal cue of the user.

10. The computer program product of claim 8, wherein the relationship is built on one or more characteristics, and wherein the one or more characteristics include at least one of trust of the user and empathy with the user.

11. The computer program product of claim 8, wherein the first response to the input from the user incorporates the connection point by including at least one of a reference to a previous interaction with the user, a first mirroring of the mental state of the user, a second mirroring of the emotional state of the user, a third mirroring of the tone of voice of the user, a second response to the verbal cue of the user, a third response to the non-verbal cue of the user, a first summarization of a first understanding of a feeling expressed by the user, a summarization of a second understanding of a need expressed by the user, and a manifestation of a thoughtful question based on the previous interaction with the user.

12. The computer program product of claim 8, wherein the program instructions to output the first response to the user further comprises:
program instructions to communicate a first reason an action was taken to help the user understand why the action was taken; and
program instructions to communicate a second reason a recommendation was made in order to help the user understand why the recommendation was made.

13. The computer program product of claim 12, wherein a first communication of the first reason the action was taken and a second communication of the second reason the recommendation was made is implemented through a dialogue management system and a machine learning algorithm, wherein the dialogue management system and the machine learning algorithm understands a context, a continuity, and a subtlety of a human-to-human interaction.

14. The computer program product of claim 8, further comprising:
program instructions to recognize one or more relationships of the user;
program instructions to learn about a degree of importance of the one or more relationships of the user; and
program instructions to consider the one or more relationships in at least one of a corresponding input and a corresponding output.

15. A computer system comprising:
one or more computer processors;
one or more computer readable storage media;
program instructions collectively stored on the one or more computer readable storage media for execution by at least one of the one or more computer processors, the stored program instructions comprising:
program instructions to initiate an interaction between a digital human companion and a user in response to an input from the user;
program instructions to derive a connection point from the interaction between the digital human companion and the user to build a relationship with the user;
program instructions to prepare a first response to the input from the user incorporating the connection point;
program instructions to output the first response to the user; and
program instructions to incorporate a set of feedback received from the user to customize the digital human companion to increase a first level of intelligence and a second level of adaptability of the digital human companion.

16. The computer system of claim 15, wherein the connection point is at least one of a mental state of the user, an emotional state of the user, a tone of voice of the user, a verbal cue of the user, and a non-verbal cue of the user.

17. The computer system of claim 15, wherein the relationship is built on one or more characteristics, and wherein the one or more characteristics include at least one of trust of the user and empathy with the user.

18. The computer system of claim 15, wherein the first response to the input from the user incorporates the connection point by including at least one of a reference to a previous interaction with the user, a first mirroring of the mental state of the user, a second mirroring of the emotional state of the user, a third mirroring of the tone of voice of the user, a second response to the verbal cue of the user, a third response to the non-verbal cue of the user, a first summarization of a first understanding of a feeling expressed by the user, a summarization of a second understanding of a need expressed by the user, and a manifestation of a thoughtful question based on the previous interaction with the user.

19. The computer system of claim 15, wherein the program instructions to output the first response to the user further comprises:
program instructions to communicate a first reason an action was taken to help the user understand why the action was taken; and
program instructions to communicate a second reason a recommendation was made in order to help the user understand why the recommendation was made.

20. The computer system of claim 15, further comprising:
program instructions to recognize one or more relationships of the user;
program instructions to learn about a degree of importance of the one or more relationships of the user; and
program instructions to consider the one or more relationships in at least one of a corresponding input and a corresponding output.
